(19) United States
(12) Patent Application Publication
(10) Pub. No.: US 2010/0061434 A1
(43) Pub. Date: Mar. 11, 2010

(54) DSL Loop Topology Recognition Based on the Insertion Loss (Hlog) Measurements

(75) Inventors: Shailendra Kumar Singh, Unnao (IN); Patrick Duvaut, Tinton Falls, NJ (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Conexant Systems, Inc., Newport Beach, CA (US)

(21) Appl. No.: 12/359,885

(22) Filed: Jan. 26, 2009

Related U.S. Application Data
(60) Provisional application No. 61/094,959, filed on Sep. 7, 2008.

(51) Int. Cl. H04B 3/46

(52) U.S. Cl. 375/224

(57) ABSTRACT

The topology of a digital subscriber line loop can play an important role in provisioning service. For example, knowledge of certain topological features in a loop can enable telecommunications companies to make better decisions about the kinds of services that can be provisioned on that loop. Additionally, knowledge of those topological features can also assist field engineers in troubleshooting problems in the field. A topology recognition engine can provide key topological features such as the loop length, presence of single and multiple bridge taps and the length of single bridge taps on a loop.

### CROSS-REFERENCE TO RELATED APPLICATION

Under 35 U.S.C. 119, this application claims priority to, and the benefit of, U.S. Provisional Patent Application entitled, “DSL Loop Topology Recognition Based on the Insertion Loss (Hlog) Measurements,” having Ser. No. 61/094,959, filed on Sep. 7, 2008, which is incorporated by reference in its entirety.

### BACKGROUND OF THE INVENTION

1. Field of the Invention

The present invention relates generally to digital subscriber line (DSL) systems. More particularly, the present invention relates to topology recognition in DSL systems.

2. Related Art

The topology of a DSL loop can play an important role in provisioning service. For example, knowledge of certain topological features in a loop can enable telecommunications companies to make better decisions about the kinds of services that can be provisioned on that loop. Additionally, knowledge of those topological features can also assist field engineers in troubleshooting problems in the field. Some of the key features that can have significant impact on DSL service are the loop length, the gauge of the loop and the presence of the bridge taps and their length. Typically, the telecommunications company is aware of the gauge information at the time of the deployment of the loop. However, after the time of deployment, the topology may change due to the lengthening or shortening of the loop length and the addition or removal of a bridge tap. A bridge tap is typically an open-ended length of wire attached to a loop. This often occurs because in the deployment of a new user, when possible, an existing unused loop is tapped into, rather than laying a new loop into the ground. Furthermore, rather than digging up the unused portion of the loop, the unused wire is left in the ground where it becomes a bridge tap to the newly deployed loop. Because of the sometimes ad hoc changes to the topological features of a given loop, it is often difficult for a telecommunications company to keep track of the actual loop length and the bridge tap information.

FIG. 1 illustrates some of these topological features. Loop 104 connects central office (CO) 102 to customer premises equipment (CPE) 106. The length of loop 104 is its loop length.

FIG. 2A illustrates additional topological features in the presence of a bridge tap. Loop 204 connects CO 202 and CPE 206 having a loop length. Bridge tap 208 is coupled to loop 204. Both the length of the bridge tap and the position along loop 204 are key topological features.

FIG. 2B illustrates topological features in the presence of multiple bridge taps. Loop 216 connects CO 212 and CPE 214 having a loop length. Bridge taps 218 and 220 are connected to loop 216. Both bridge taps 218 and 220 have respective lengths and positions along loop 216.

In DSL communications, the communications bands are divided channels known as bins or tones. For example, typical DSL bins are 4.3125 kHz wide. As mentioned above, a DSL system can obtain the insertion loss obtained in the training and performance testing, which is referred to as Hlog. DSL physical layer standards provide options for obtaining the Hlog data across all used bins. On occasion, Hlog data is not provided on a per bin basis, but given per groups of bins. For example, Hlog data may only be provided for bin groups of 2, 4 or 8 bins. DSL physical standards such as (G.992.3/.5 and G.993) have options for obtaining the Hlog data through Training or dual-end line testing (DELT) Management Information Base (MIB) parameters. Unfortunately, raw Hlog data is unintelligible and does not in its raw form provide useful information about the topology to the telecommunications company.

Accordingly, various needs exist in the industry to address the aforementioned deficiencies and inadequacies.

### SUMMARY OF INVENTION

The topology of a DSL loop can play an important role in provisioning service. For example, knowledge of certain topological features in a loop can enable telecommunications companies to make better decisions about the kinds of services that can be provisioned on that loop. Additionally, knowledge of those topological features can also assist field engineers in troubleshooting problems in the field. A topology recognition engine can provide key topological features such as the loop length, presence of single and multiple bridge taps and the length of single bridge taps on a loop. In addition a reliability measure can be calculated to accompany the length calculations.

Other systems, methods, features, and advantages of the present disclosure will be or become apparent to one with ordinary skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates topological features in a straight loop;

FIG. 2A illustrates additional topological features in the presence of a bridge tap;

FIG. 2B illustrates topological features in the presence of multiple bridge taps;

FIG. 3 is a block diagram illustrative of an exemplary system which uses a topology recognition engine;

FIG. 4 is a block diagram of an implementation of the topology recognition engine;

FIG. 5 shows a flow chart illustrating the operation of the topology recognition engine;

FIG. 6 illustrates exemplary Hlog measurements for a variety of straight loops;

FIG. 7 shows a plot of the slope against the loop length for 24 American wire gauge (AWG) straight loop;

FIG. 8 shows a plot of the slope against the loop length for 26 AWG straight loop;

FIG. 9 illustrates an example of the Hlog measurements with a single bridge tap;

FIG. 10 illustrates additional examples of the Hlog measurements with a single longer bridge tap;

FIGS. 11 and 12 show reliability measures for 24 AWG and 26 AWG loops respectively;

FIG. 13 shows the Hlog function after imposing a smoothing operation;

FIG. 14 shows a graph of the inverse of the period of the nodes as a function of the length of the bridge taps;

FIG. 15 shows the performance results of the topology recognition engine in table form;

FIGS. 16 and 17 are graphs illustrating the errors presented in FIG. 15 graphically for 24 AWG and 26 AWG straight loops, respectively;

FIGS. 18 and 19 show the error histogram for these straight loop tests for 24 AWG and 26 AWG, respectively;

FIG. 20 shows the standard deviation of the derivative of the slope of the Hlog measurements; and

FIGS. 21 and 22 are graphs illustrating the errors in bridge tap lengths for 24 AWG and 26 AWG bridge taps, respectively.

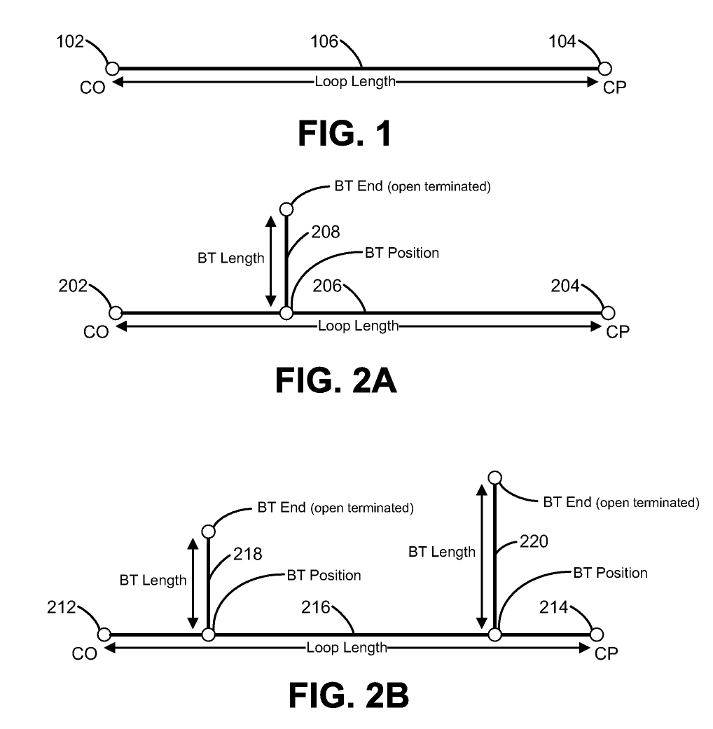

### DETAILED DESCRIPTION

A detailed description of embodiments of the present invention is presented below. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

A topology recognition engine can be used to take the raw Hlog measurements and produce topological features of a loop. The topology recognition engine applies pattern-recognition (non parametric-modeling) methods to perform a centralized analysis of the measurement data. The topology recognition engine can classify loops and identify bridge taps.

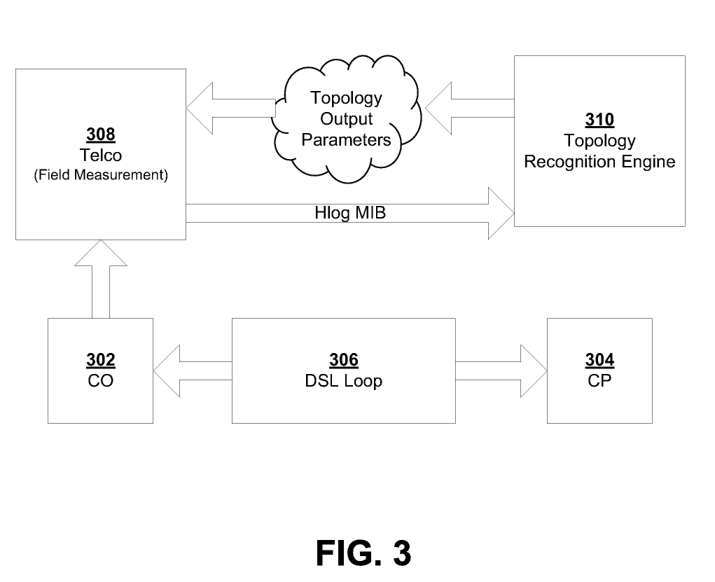

FIG. 3 is a block diagram illustrative of an exemplary system which uses a topology recognition engine. Exemplary CO 302 is connected to exemplary CPE 304 through DSL loop 306 of unknown topology. The CO can report the Hlog measurements to telecommunications company 308 through the use of an Hlog MIB. Telecommunications company 308 supplies the Hlog measurements to topology recognition engine 310, determines topological features, and reports them back to telecommunications company 308 where they can be used for service provisioning or troubleshooting. More specifically, the standard defined training sequence enables the downstream Hlog measurement to be observed at CPE 304 and the upstream Hlog measurement to be observed at CO 302. The same standards also facilitate the sharing of the Hlog between CO 302 and CPE 304 by message exchange mechanism. The raw measurement data encapsulated in the standard defined format is exchanged between CO 302 and CPE 304. Reliability of the measurements and message exchange protocol is insured by specifically designed pseudo random training sequence and low bit rate binary phase shift key (BPSK) transmission of the messages. Message exchange uses ACK/NACK protocol with retransmission to insure the integrity of the message exchange. Through these mechanisms the raw Hlog measurements at the end of a session are available at both CO 302 and CPE 304, where CO 302 can report the Hlog measurements topology recognition engine 310 either directly or through telecommunications company 308.

While depicted as separate from telecommunications company 308 and CO 302, one of ordinary skill in the art will recognize that topology recognition engine 310 can be incorporated as part of the infrastructure of telecommunications company 308 or part of CO 302. In addition, an alternate implementation of topology recognition engine could be implemented as part of CPE 304 where the results could be reported back to CO 302 and used by telecommunications company 308. Topology recognition engine 310 as one of ordinary skill in the art would recognize could be implemented on any typical computing device, either as part of a general purpose computing device or a computing device designed especially for this purpose. Using the telecommunications company proprietary methods, the raw Hlog measurements are collected at layer 0. The Hlog, thus obtained for both the upstream and downstream bands, is fed to the topology recognition engine which has capability to analyze the measurement data online as well as offline. Also the engine need not be located at the same location where measurements are performed. The engine converts the measurement data from the standard defined format to a floating point representation. The measurement data is processed and analyzed by the analysis engine to obtain the topological features of the device under test which form the outcome of the engine.

It should also be noted that topology recognition engine 310 need not work on all Hlog data. For example, in some circumstances, CPEs may not be equipped to collect downstream Hlog measurements and transmit them back to the CO. In such a case, topology recognition engine 310 can operate solely on upstream Hlog data.

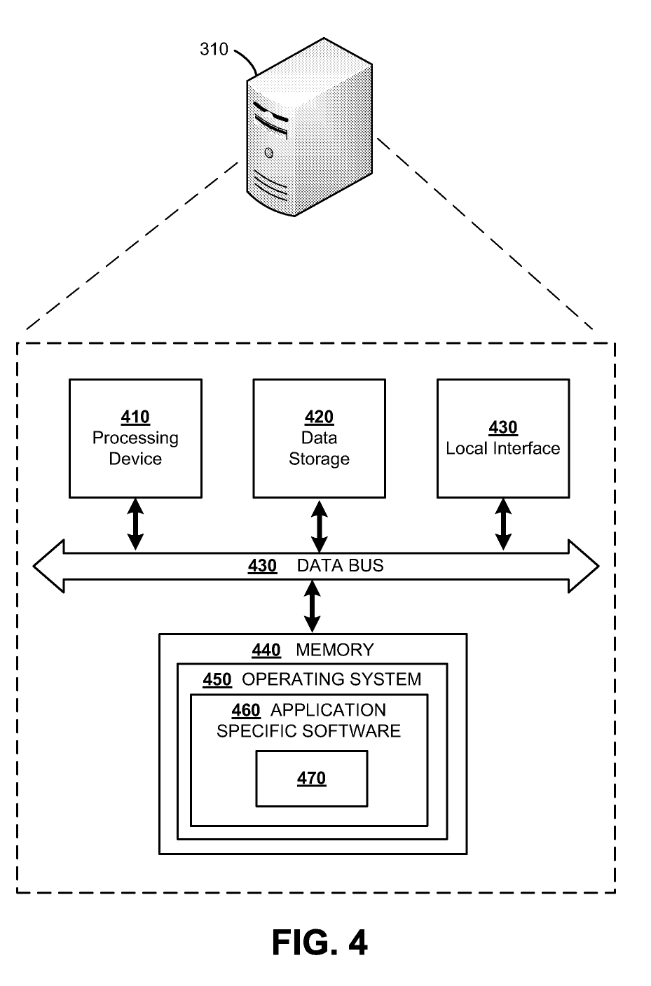

FIG. 4 is a block diagram of an implementation of the topology recognition engine. In accordance with certain embodiments, the steps for topology analysis described in this disclosure may be incorporated in software within a topology recognition engine which in turn may be part of a larger computing device. One of ordinary skill in the art will appreciate that a computing device can comprise other components, which have been omitted for purposes of brevity. Generally, the topology recognition engine 310 may include a processor 410, a memory component 440 (which may include volatile and/or nonvolatile memory components), and a data storage component 420 that are communicatively coupled via a local interface 430.

The local interface 430 may have additional elements, which are omitted for simplicity, such as controllers, buffers (caches), drivers, repeaters, and receivers to enable communications. The local interface can be used to receive the Hlog measurements and to transmit topological features resulting from the topology analysis. Further, the local interface may include address, control, and/or data connections to enable appropriate communications among the aforementioned components. The processor 410 may be a device for executing software, particularly software stored in the memory component 440. The processor 410 can be any custom made or commercially available processor, a central processing unit (CPU), an auxiliary processor among several processors associated with a computing device, a semiconductor based microprocessor (in the form of a microchip or chip set), a macroprocessor, or generally any device for executing software instructions.

The memory component 440 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory component 440 may incorporate electronic, magnetic, optical, and/or other types of storage media. One should note that some embodiments of the memory component 440 can have a distributed architecture (where various components are situated remotely from one another) but can be accessed by the processor 410.

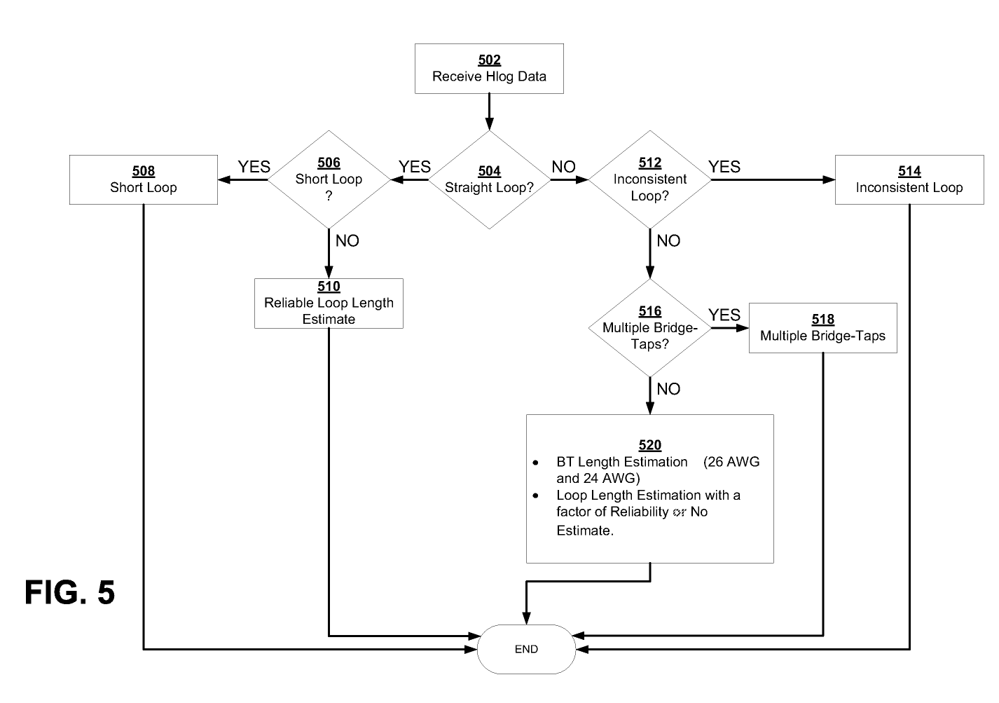

The software in memory component 440 may include one or more separate programs, each of which includes an ordered listing of executable instructions for implementing logical functions. In the example shown in FIG. 4, the software in the memory component 440 may include an operating system 450. Furthermore, the software residing in memory 440 may include application specific software 460, which may further comprise topology recognition module 470, which is the core analysis module performing the steps of FIG. 5. It should be noted, however, that these modules can be implemented in software, hardware or a combination of software and hardware. The operating system 450 may be configured to control the execution of other computer programs and provides scheduling, input-output control, file and data management, memory management, and communication control and related services.

A system component and/or module embodied as software may also be constructed as a source program, executable program (object code), script, or any other entity comprising a set of instructions to be performed. When constructed as a source program, the program is translated via a compiler, assembler, interpreter, or the like, which may or may not be included within the memory component 440, so as to operate properly in connection with the operating system 450. When the computing device is in operation, the processor 410 may be configured to execute software stored within the memory component 440, communicate data to and from the memory component 440, and generally control operations of the computing device pursuant to the software. Software in memory may be read by the processor 410, buffered within the processor 410, and then executed.

FIG. 5 shows a flow chart illustrating the operation of the topology recognition engine. At step 502, the raw Hlog measurements are received by the topology recognition engine.

At step 504, the topology recognition engine determines whether or not the loop (e.g., unknown loop 306) is a straight loop. The presence of a bridge tap reflects a transmitted signal back onto the loop and depending on the frequency; this yields constructive or destructive interference. The result is that at some frequencies, the Hlog encounters a node, that is, a point of considerable attenuation due to destructive interference, which appears as a minima in the frequency domain channel response. Therefore, a straight loop should exhibit an Hlog which is free of these nodes. From transmission line theory, it is known that Hlog for a straight loop is a monotonically decreasing continuous function of frequency and can be shown to be proportional to the square root of the frequency. Therefore, any deviation from this monotonically decreasing continuous function is a departure from the straight loop topology.

There are several approaches to exploiting this relationship between ideal Hlog measurements and the frequency. In all cases, the objective is to measure the deviation from an ideal straight loop measurement. If the deviation is sufficiently great, a bridge tap is likely present. To measure the deviation several approaches can be taken.

One approach is to take the first order derivative of the available Hlog measurements, then apply a low pass filter to the derivative in order to exclude noise. The cutoff frequency used is dependent on the longest bridge tap considered. The longer the bridge tap, the shorter the period, that is the distance between consecutive nodes. Therefore, the cutoff frequency should be selected to be greater than the inverse of the period of the longest bridge tap considered. The variance of the filtered derivative is computed and compared to a threshold. If the threshold is exceeded, a bridge tap can be flagged.

Another approach is to use the square of Hlog which should be a linear function of frequency. Again a low pass filter can be used to exclude high frequency noise. A linear fit is applied to the optionally filtered square of Hlog, and the variance of the fit can be compared to a threshold. If the threshold is exceeded a bridge tap can be flagged.

Yet another approach is to look for the nodes in Hlog measurements. The presence of nodes is indicative of the presences of bridge taps. The choice of approaches can depend on the availability of Hlog measurements for the various bands used.

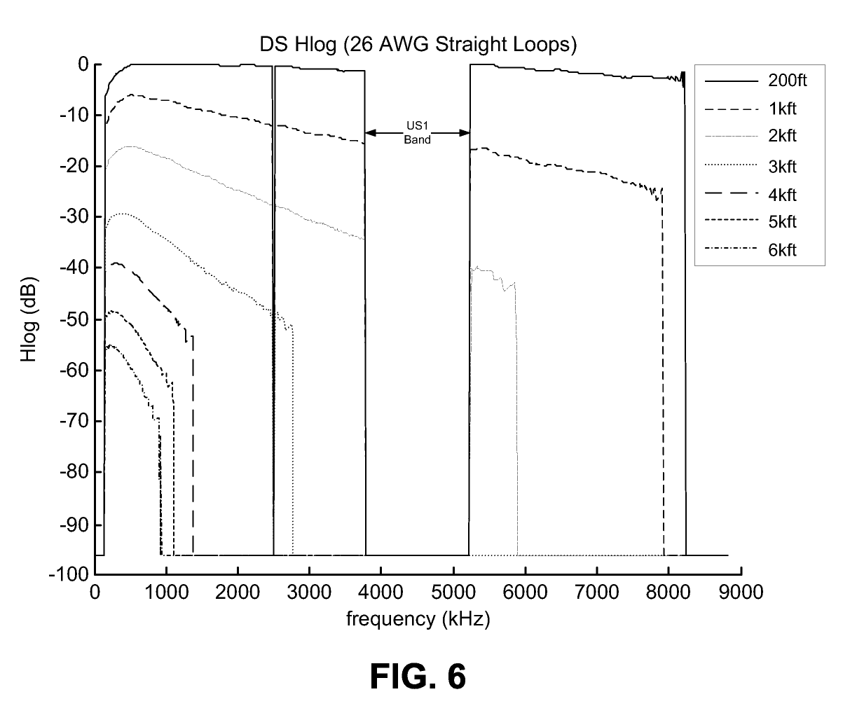

FIG. 6 illustrates exemplary Hlog measurements for a variety of straight loops. It should be noted that the Hlog measurements are only for the downstream insertion loss, so the first downstream (DS1) band of frequencies (from 25 kHz to 276 kHz up to 3.75 MHz) and the second downstream (DS2) band of frequencies (from 5.2 MHz up to 8.5 MHz) are shown. There is a gap for the first upstream (US1) band of frequencies (from 3.75 MHz up to 5.2 MHz). Topology recognition engine at step 504 can employ any of the approaches described above to determine the deviation from a straight loop, using any available approach as mentioned above. When DS1 Hlog data is available as shown in FIG. 6, the approach of determining whether the variance of the derivative of the Hlog data exceeds a predetermined threshold works well.

If at step 504, the loop is determined to have a bridge-tap, the topology recognition engine goes to step 512 as described below. If the loop is determined to be a straight loop, a determination is made at step 506 as to whether the loop is short. A short loop in the context of this exemplary embodiment of the topology recognition engine is a loop of less than 200 feet. When the loop length is less than 200 feet, the noise in the measurements and other factors make it difficult to determine the length accurately. The topology recognition engine determines a reliable length measurement by measuring the slope of the Hlog measurements against frequency. If the slope is above a certain threshold, the loop is deemed too short to measure, in which case the loop as flagged as a short loop at step 508. The value of this threshold can be determined from the reference values described for use in step 510.

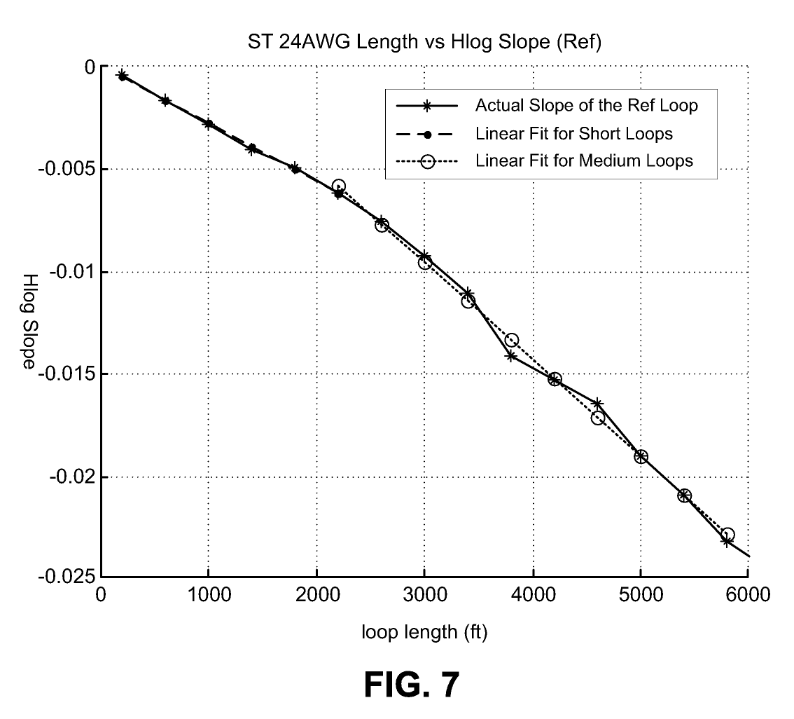

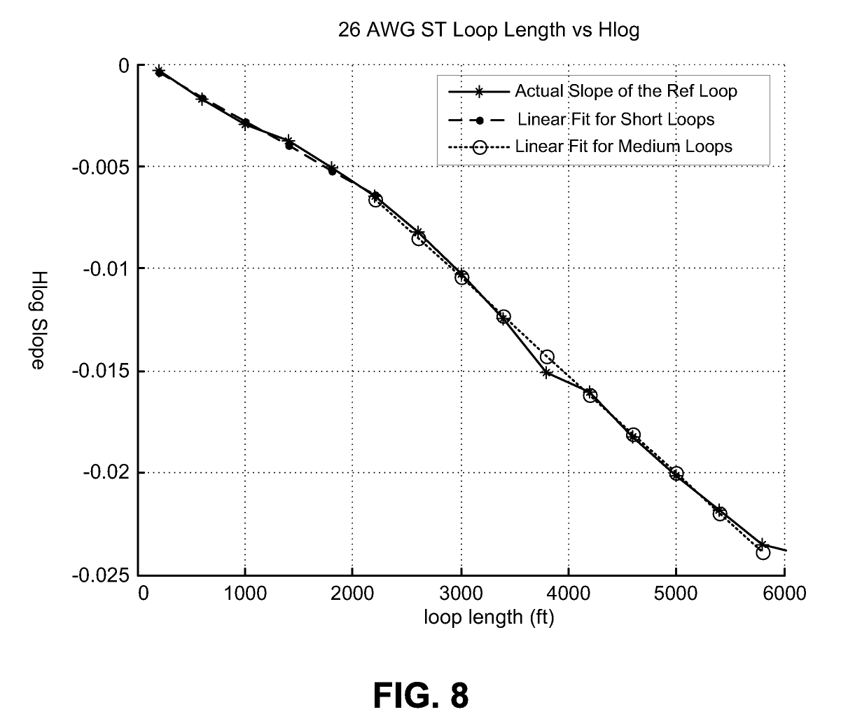

If the loop is determined not to be short a reliable loop length estimate is made at step 510. It is known that the slope of the Hlog measurements as a function of frequency is indicative of the loop length (at least up to 6000 ft). FIG. 7 shows a plot of the slope against the loop length for 24 AWG straight loop. FIG. 8 shows a plot of the slope against the loop length for 26 AWG straight loop. A reference table or graph can be obtained experimentally. Using the reference table, the slope of the Hlog measurements against frequency can be calculated using linear regression techniques. This slope value is then compared to the reference values and a loop length can be determined. The variance of the linear fit can serve as the reliability factor. Since the gauge cannot be determined from the Hlog measurements, the topology recognition engine provides two length estimates corresponding to the two gauges used in DSL communications.

The slope of Hlog measurements as a function of frequency can be used to determine loop length especially when data for many frequencies is available. However, where data is scarce, such as when only the Hlog measurements for US1 are available, the slope of the square of the Hlog measurements can provide a more accurate indicator of the loop length. Again, the slope of the square can be compared to reference values for various loop lengths.

At step 512, the topology recognition engine decides if it can determine whether there is an inconsistent loop. As mentioned above, the presence of a bridge tap can introduce nodes where the insertion loss increases. These are usually well formed and easily spotted. If the Hlog measurements as a function of frequency do not match these properties and specifically, a linear regression fit of the Hlog measurements as a function of frequency yields a very high variance, then the loop is classified as inconsistent at step 514. An inconsistent loop may be a DSL loop with so many bridge taps or other topological features that their signature impact on the Hlog function obscures each other and distinct patterns in the Hlog function are simply not discernable.

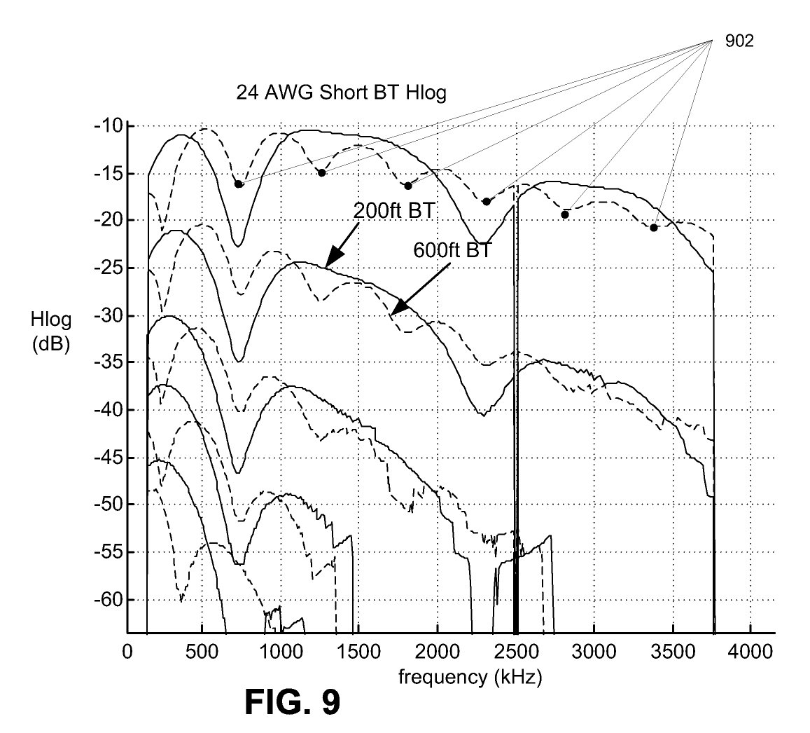

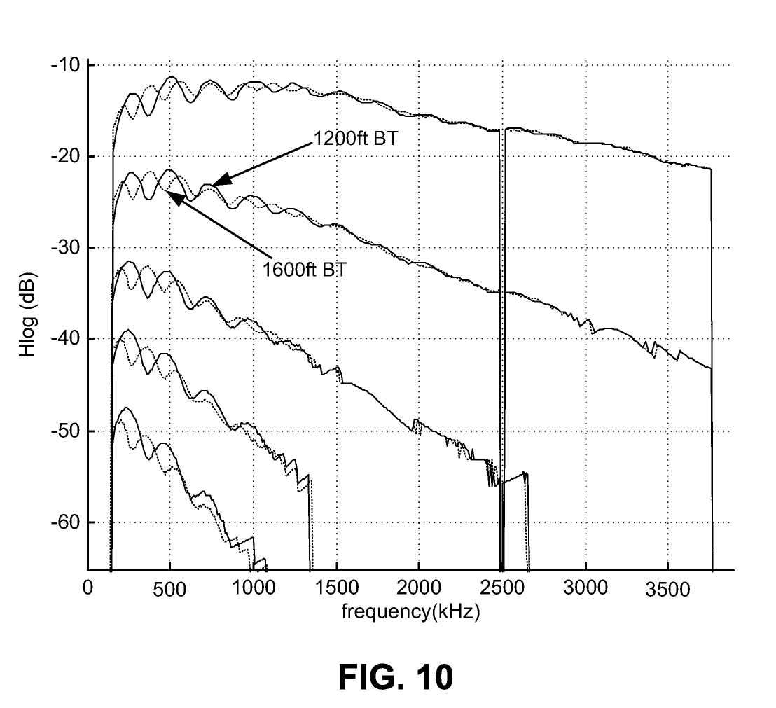

If the loop is not found to be inconsistent, a determination is made as to whether there are multiple bridge taps at step 516. As mentioned above, bridge taps introduce nodes in the Hlog measurements. Each bridge tap introduces periodic nodes in the Hlog function. If there is a single bridge tap, all the nodes should be periodic. The topology recognition engine determines if there is a single bridge tap by examining whether or not the nodes are periodic. In addition, the nodes are identified by the min-max span of the slope (or derivative), in the neighborhood of the nodes. This is to prevent misidentification of a node due to an errant measurement or noise. In addition, a smoothing function such as a median filter can be applied to the Hlog measurements to eliminate misidentification of nodes. If multiple bridge taps are determined the topology recognition engine identifies the loop as such at step 518. FIG. 9 illustrates an example of the Hlog measurements with a single bridge tap. Node 902 indicates a period node in the 600 ft bridge tap example. The dashed lines represent the Hlog measurements with a 200 ft bridge tap. The multiple sets of plots illustrate 200 ft and 600 ft bridge taps for various loop lengths. FIG. 10 illustrates additional examples of the Hlog measurements with a single longer bridge tap.

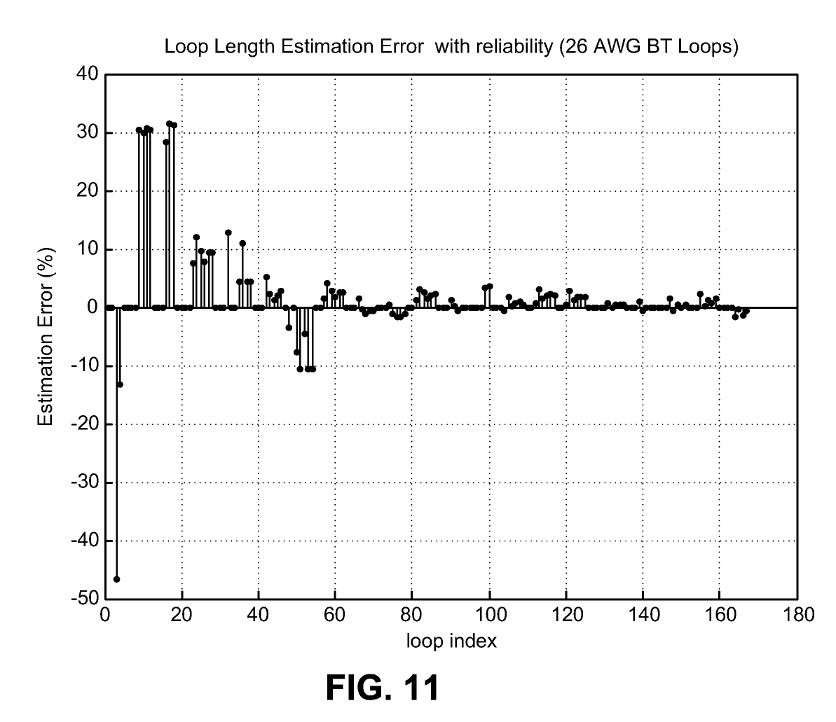

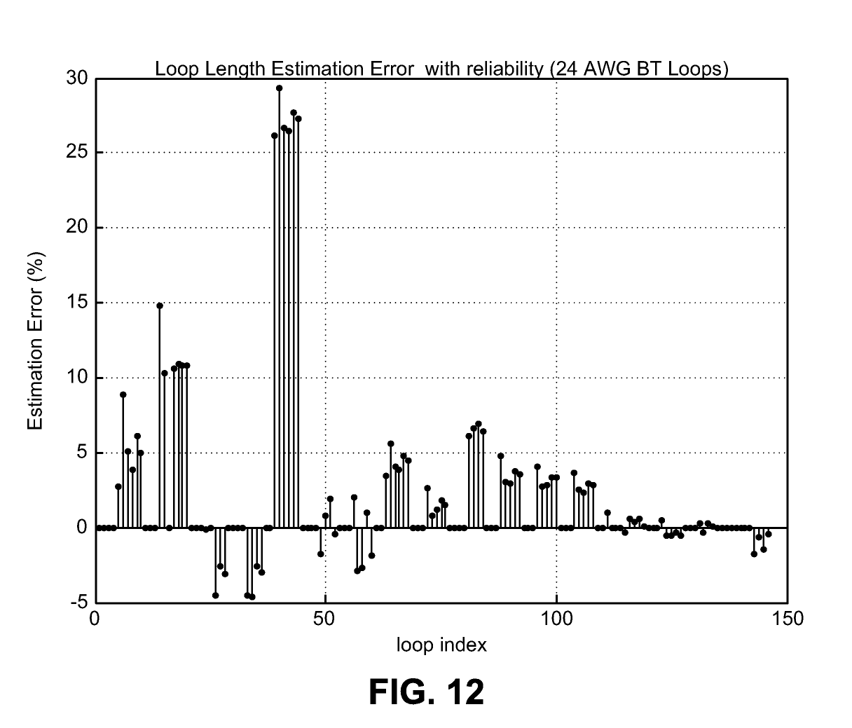

If at step 516 the topology recognition engine determines a single bridge tap, the topology recognition engine estimates the bridge tap length and the loop length. The loop length is obtained much in the same way as in step 510. It has been observed that the impact of a single bridge tap the average slope of the Hlog function primarily depends on the loop length. A linear regression fit of the Hlog function is performed to obtain the average slope. The variance of the fit yields the reliability measure. Results of this approach are shown in FIGS. 11 and 12 for 24 AWG and 26 AWG loops, respectively. If the reliability measure indicates an unreliable estimate, the topology recognition engine could simply provide no estimate.

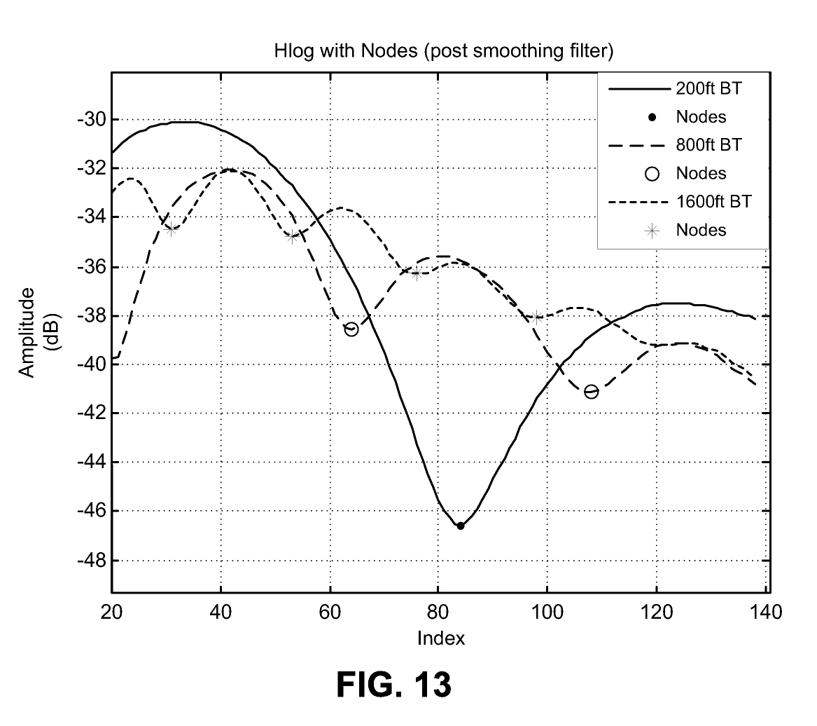

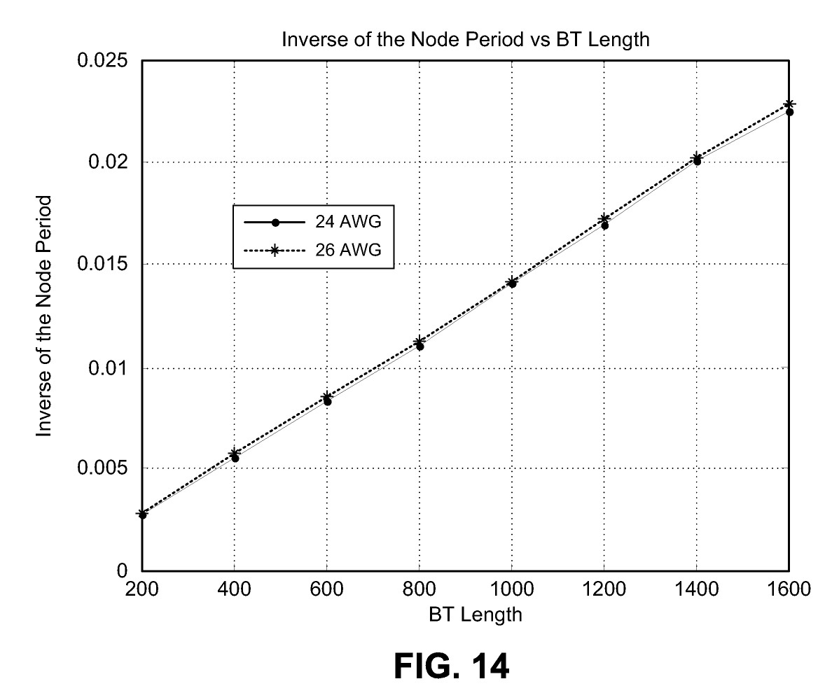

The bridge tap length in a single bridge tap loop is inversely proportional to the period of the nodes. The topology recognition engine performs some smoothing to remove the errant measurements as described above. FIG. 13 shows the Hlog function after imposing a smoothing operation. The nodes for various length single bridge taps can be seen more clearly and are periodic. It should be noted that the period of the 200 ft bridge tap is so long that it is difficult to distinguish between bridge taps shorter than 200 ft. In such an event the topology recognition engine simply categorizes the bridge tap length as less than 200 ft. FIG. 14 shows a graph of the inverse of the period of the nodes as a function of the length of the bridge taps. Therefore, by comparing the node period to this graph the bridge tap length can be obtained. Of course, the graph can be expressed as a linear equation between the inverse of the period of the nodes and the bridge tap length. Again, the length is dependent on the gauge and since the gauge of the bridge tap may not be known by the topology recognition engine, two length values based on the two gauges used in DSL are provided. It should be noted that due to the higher attenuation of the reflected wave in a long bridge tap, very long bridge taps (longer than 1600 ft) are likely to have little impact on the loop and are not likely to be detected.

To summarize, the function of the topology analysis receives the raw Hlog measurements and provides an identification of the loop as a straight loop, a single bridge tap loop, a multiple bridge tap loop or an inconsistent loop. For a straight loop, the topology recognition engine either sets a short loop flag or provides an estimate of the loop length. For a single bridge tap loop, the topology recognition engine provides a bridge tap length or sets a short bridge tap flag and an estimate of the loop length with a reliability measure. The loop and bridge tap length estimates are dependent on the gauge of the loop. If the gauge information is not available, the engine provides an estimate of the length corresponding to each gauge (24 and 26 AWG). Generally the estimate of the length is highly reliable (less than +/−5% error); however for certain topologies, depending on the classification of the loops, it's inherently difficult to estimate the loop length. In such cases the loop length estimate is provided with a reliability factor.

An embodiment of the topology recognition engine described above was subjected to testing under simulated conditions. The tests were run using VDSL2 CO and CPE platforms connected through a big spool loop simulator for 24 AWG and 26 AWG loops. Straight loops were tested up to a length of 6000 feet. Loops with single bridge taps were tested up to a bridge tap length up to 1600 feet.

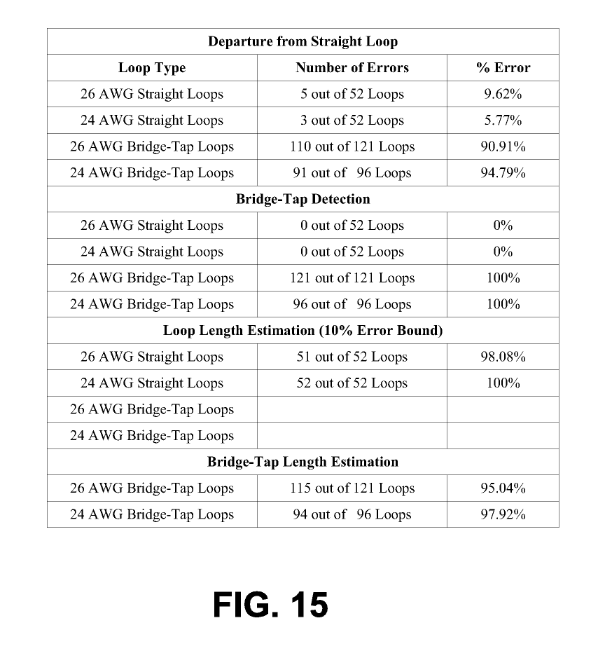

The performance results of the topology recognition engine are given in table form in FIG. 15. From these results, it can be seen that only 7% of 24 AWG loops were erroneously flagged as non-straight loops, and 10% of 26 AWG loops were erroneously flagged. This is due to the fact that even in the case of the straight loops some of the measurements have partly inconsistent Hlog values.

In case of bridge tap loops, some of scenarios are not correctly flagged as departure from straight loop (less than 10%). This is due to the fact that the impact of these bridge taps on the Hlog is not significant. This may happen if the length of the bridge tap is too long and causes the signals reflected from the BT end to have insignificant impact on Hlog. As the presence of the bridge tap loop classification is based on the identification of the occurrence of the nodes in the Hlog, the analysis engine accurately identifies the presence of at least one node due to the bridge tap. All the loops have been correctly classified as a bridge tap loop or non-bridge tap loop.

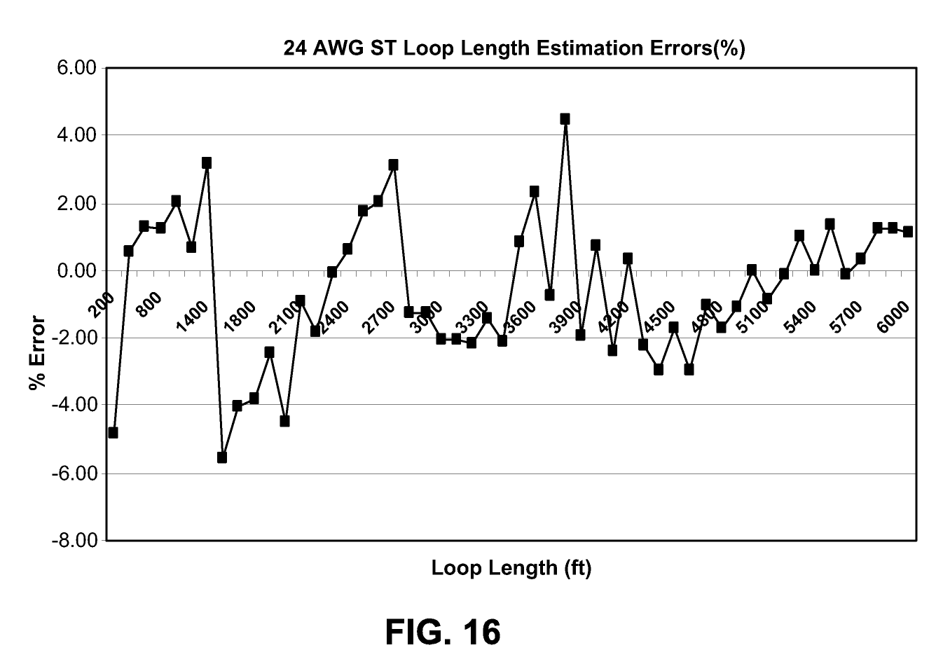

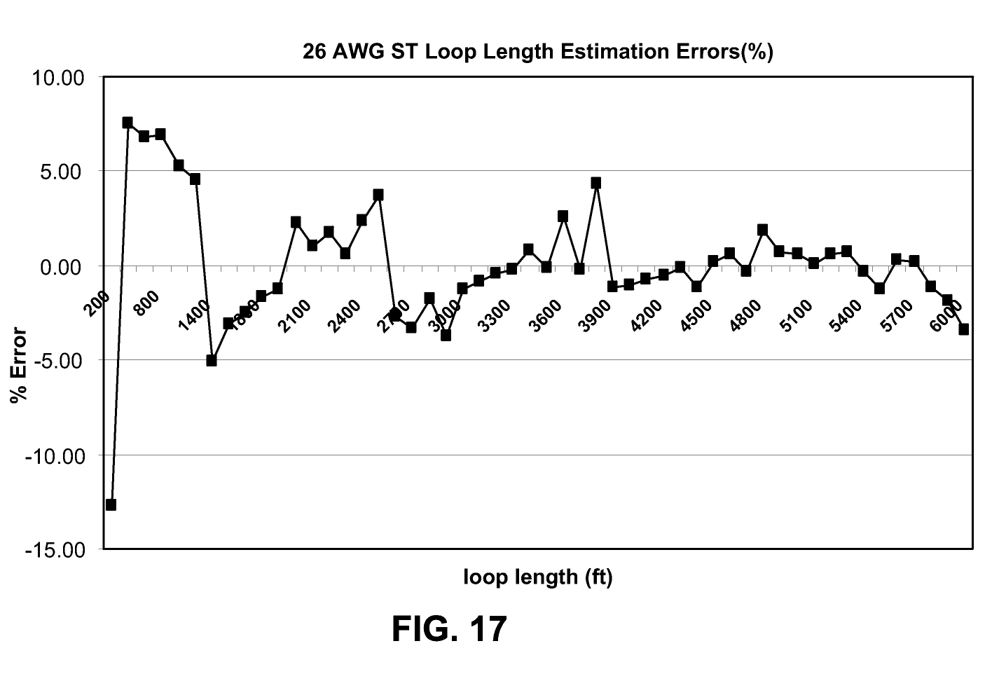

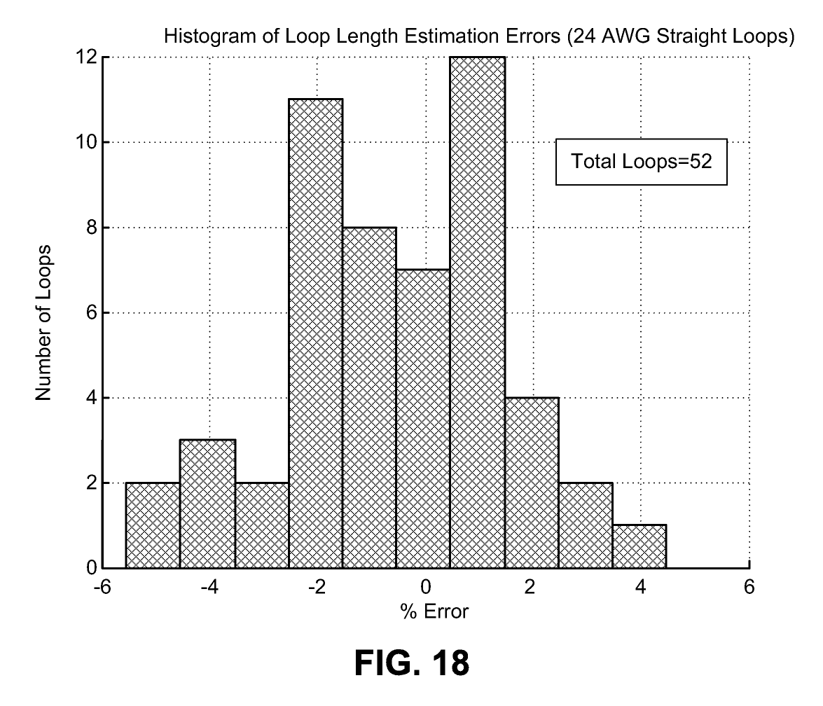

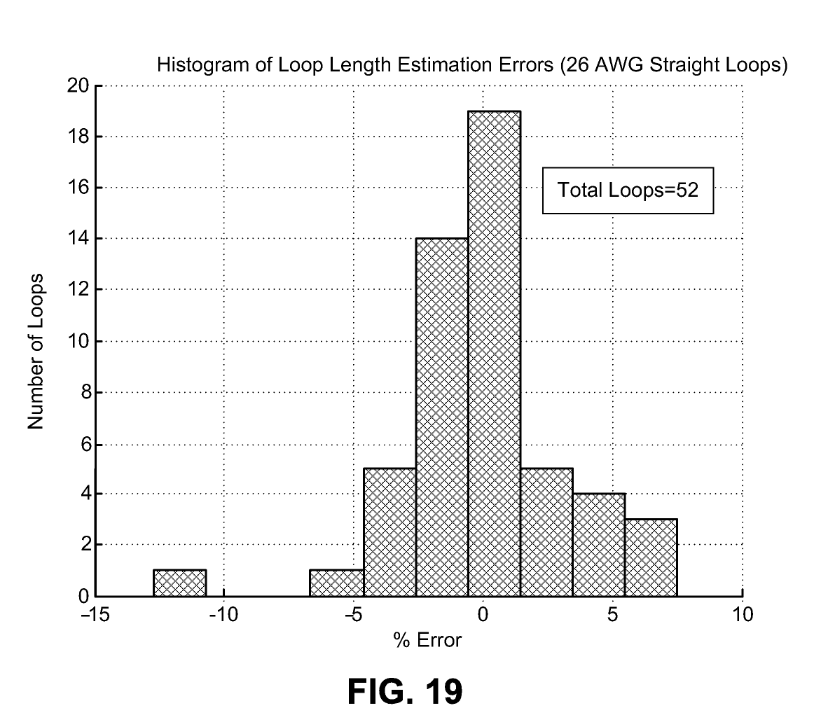

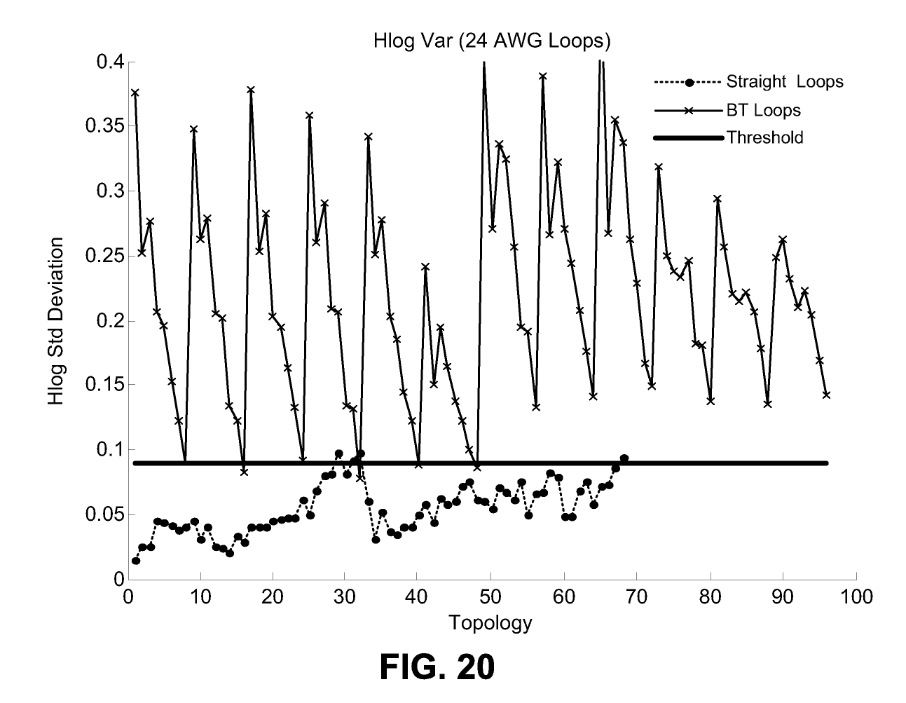

Also from FIG. 15 we can see that the loop length is accurately estimated within the +/−10% error bound. In addition FIG. 16 and FIG. 17 are graphs illustrating the errors presented in FIG. 15 graphically for 24 AWG and 26 AWG straight loops, respectively. FIGS. 18 and 19 show the error histogram for these straight loop tests for 24 AWG and 26 AWG, respectively. FIG. 20 shows the standard deviation of the derivative of the slope of the Hlog measurements. Since the standard deviation is the square root of the variance, the same principles apply. It can be seen that for the threshold used in this example, the straight loop topologies and the topologies with a bridge tap are separated by this threshold.

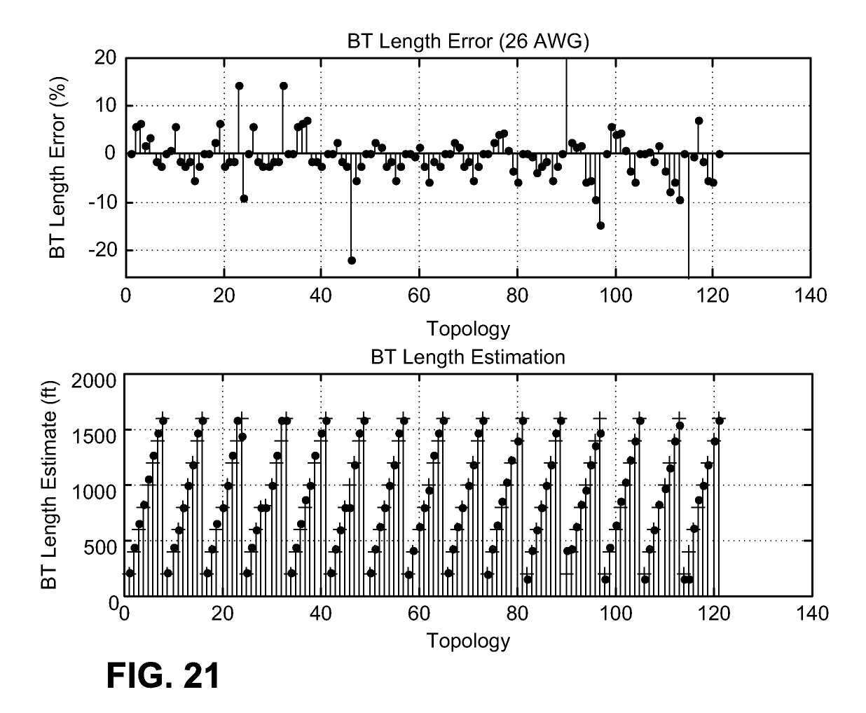

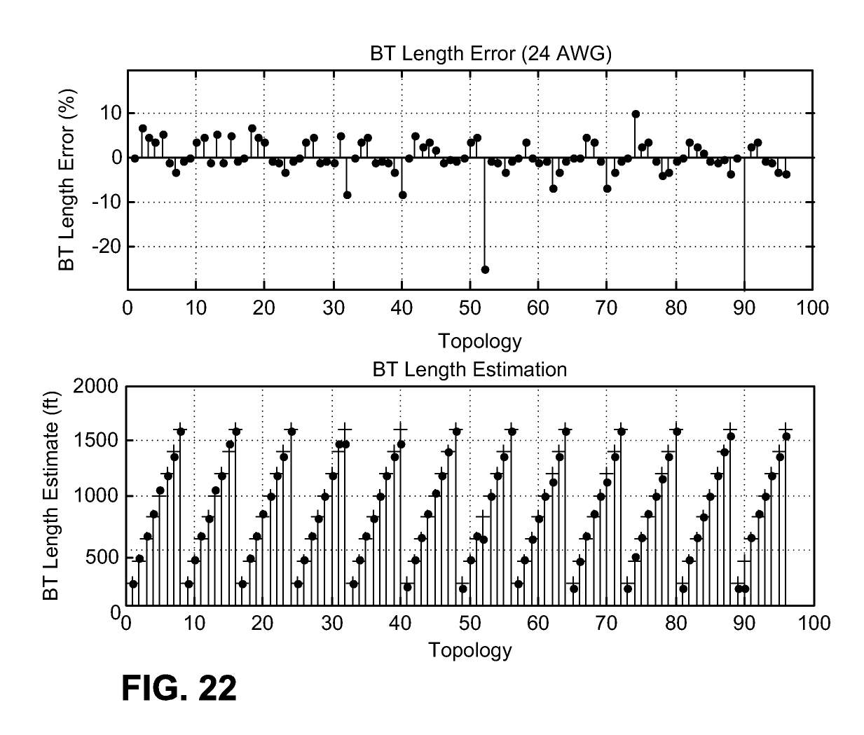

The bridge tap length estimates provided in the same table are also within +/−10% error bound for 95% of scenarios. This can also be seen graphically. FIG. 21 and FIG. 22 are graphs illustrating the errors in bridge tap lengths for 24 AWG and 26 AWG bridge taps, respectively. The lower graphs in FIGS. 21 and 22 show the estimated bridge tap lengths (circle) and the actual bridge tap lengths (plus). The presence of bridge taps makes it difficult to estimate the loop length of the DSL loop. It is for this reason that the topology recognition engine provides a reliability estimate especially in the cases of a loop with a single bridge tap.

The Hlog based topology recognition engine described herein can provide the much needed information to the telecommunications company. The topological information provided by the engine is easy to understand and it can be used by the field engineers to diagnose the field problems and provision the DSL services. The algorithms used in the analysis are easily portable to other DSL platforms.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed:

1. A method for extracting topological features about a digital subscriber line (DSL) loop from insertion loss (Hlog) measurements comprising:
computing a deviation of the Hlog measurements from straight loop Hlog measurements; and
determining whether a bridge tap is present based on whether the deviation exceeds a predetermined threshold.

2. The method of claim 1, wherein computing the deviation comprises:
computing a first order derivative of the Hlog measurements apply a low pass filter to the first order derivative to produce a filtered derivative; and
computing a variance from the filtered derivative.

3. The method of claim 1, wherein computing the deviation comprises:
applying a low pass filter to the Hlog measurements to produce a filtered Hlog measurements;
perform linear regression to the filtered Hlog measurements producing a variance; and
using the variance as the deviation.

4. The method of claim 1, further comprising calculating a loop length and a reliability measure.

5. The method of claim 4, wherein calculating the loop length further comprises calculating a slope of the Hlog measurements and comparing the slope to reference values.

6. The method of claim 4, wherein calculating the loop length further comprises calculating a slope of the square of the Hlog measurements and comparing the slope to reference values.

7. The method of claim 1, further comprising:
determining whether the DSL loop is an inconsistent loop; and
determining whether the DSL loop has multiple bridge taps.

8. The method of claim 1, further comprising if a single bridge tap is present determining a length for the single bridge tap by identifying a plurality of nodes in the Hlog measurements with a periodicity and calculating the length based on the periodicity.

9. A system for determining a topology for a DSL loop from Hlog measurements comprising:
a processor; and
a memory comprising instructions;
said instructions causing the processor to:
compute a deviation of the Hlog measurements from straight loop Hlog measurements; and
determine whether a bridge tap is present based on whether the deviation exceeds a predetermined threshold.

10. The system of claim 9, wherein said instructions cause the processor to compute the deviation by:
computing a first order derivative of the Hlog measurements
apply a low pass filter to the first order derivative to produce a filtered derivative; and
computing a variance from the filtered derivative.

11. The system of claim 9, wherein said instructions cause the processor to compute the deviation by:
applying a low pass filter to the Hlog measurements to produce a filtered Hlog measurements;
perform linear regression to the filtered Hlog measurements producing a variance; and
using the variance as the deviation.

12. The system of claim 9, wherein said instructions further cause the processor to determine whether the DSL loop is short.

13. The system of claim 9, wherein said instructions further cause the processor to calculate a loop length and a reliability measure.

14. The system of claim 13, wherein said instructions cause the process to calculate the loop length by calculating a slope of the Hlog measurements and comparing the slope to reference values.

15. The system of claim 13, wherein said instructions cause the process to calculate the loop length by calculating a slope of the square of the Hlog measurements and comparing the slope to reference values.

16. The system of claim 9, wherein said instructions further cause the processor to determine whether the DSL loop is an inconsistent loop and to determine whether the DSL loop has multiple bridge taps.

17. The system of claim 9, wherein if a single bridge tap is present said instructions further cause the processor to determine a length for the single bridge tap by identifying a plurality of nodes in the Hlog measurements with a periodicity and calculating the length based on the periodicity.

18. A line card, central office or DSL modem comprising the system of claim 10.

19. A system for determining a topology for a DSL loop from Hlog measurements comprising:
a means for computing a deviation of the Hlog measurements from straight loop Hlog measurements; and
a means for determining whether a bridge tap is present based on whether the deviation exceeds a predetermined threshold.

20. The system of claim 19 further comprising:
a means for determining whether the DSL loop is short; and
a means for calculating a loop length and a means for calculating a reliability measure.

21. The system of claim 19 further comprising:
a means for determining whether the DSL loop is an inconsistent loop; and
a means for determining whether the DSL loop has multiple bridge taps.

22. The system of claim 24 further comprising a means for determining a length for the single bridge tap.
